(19) United States
(12) Patent Application Publication
(10) Pub. No.: US 2003/0088870 A1
(43) Pub. Date: May 8, 2003

(54) Apparatus and method of providing channel map in a digital TV

(75) Inventor: Do San Wang, Seoul (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/284,185

(22) Filed: Oct. 31, 2002

(30) Foreign Application Priority Data
Nov. 2, 2001 (KR) P2001-68200

(51) Int. Cl. G06F 3/00; H04N 5/445; G06F 13/00

(52) U.S. Cl. 725/44; 725/56; 725/46

(57) ABSTRACT

A method and apparatus can provide and use a channel history map that shows a user's previous channel selections. Such a method and apparatus can include, for example a digital television system. A method can include building a database, which includes a plurality of channel information sets for channels that are previously tuned by a user for a prescribed time, previously tuned in sequence, or previously tuned for a preset time interval or the like and outputting or displaying a channel history map based on the database using an OSD (On Screen Display) when a request for displaying the history map is made by the user. The method can also include providing a set of channel related functions in the channel history map for the previously tuned channels concurrent selection. By providing a channel history map that shows the user's previous channel selections, the user is able to select one of the previously selected channels and perform a TV-related function in an efficient manner.

### BACKGROUND OF THE INVENTION

This application claims the benefit of Korean Application No. P2001-68200, filed on Nov. 2, 2001, which is hereby incorporated by reference as if fully set forth herein.

1. Field of the Invention

The present invention generally relates to a display apparatus or system.

2. Background of the Related Art

In general, a digital television system has a far greater number of channels than the analog television systems. For example, the digital television systems in particular cities of the U.S. with a large population may have more than several hundred channels. Since the digital television system can have such an uncountable number of channels, a TV viewer may enjoy an extended range of channel selections while each channel selection is performed in a more complicated manner.

For the reasons described above, a related art digital television system has a channel pre-selecting function such as a function for determining one or more favorite channels. Using the channel pre-selecting function of the digital television system, a user can pre-select a set of channels that he or she desires to watch upon reviewing the supplemental information of each channel. In this way, the user is able to select a desired channel in a much more efficient manner by skipping all the uninterested channels (i.e., not pre-selected) and viewing only the pre-selected channels when selecting a desired channel.

When selecting a channel for watching a desired program of the pre-selected channels, the user inputs one or more channel-up or channel-down commands by pressing a channel-up button or channel down button provided on a remote control device or on a key panel provided on the television system. For example, if a user has previously pre-selected channels 1, 3, 5, 7 and 89 as a set of registered channels and is currently watching channel 1, then one way to select and watch channel 89 is to press the channel-up buttons four times. Thereafter, if the user desires to watch channel 1 again, the user usually presses the channel-down button four times. As described above, however, the related art system has various disadvantages including creating great inconvenience to the user if many pre-selected channels exist between a previous channel that the user was previously watching and a current channel that the user is currently watching.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide an apparatus and method of providing a channel history map in a digital television system that substantially obviates one or more problems caused by disadvantages of the related art.

Another object of the present invention is to provide an apparatus and method of outputting a history map for a display apparatus that indicates a set of previous channel selections made by a user.

Another object of the present invention is to provide a method of building a database for a channel history map, where the database includes a plurality of channel information sets of channels that are previously selected and tuned by a user.

Another object of the present invention is to provide an apparatus and method that provides a selectable channel history map that indicates one or more previously selected channels, channel information sets for each channel and a plurality of channel related functions.

Another object of the present invention is to provide an apparatus and method that provides a one-click selection channel history map that indicates one or more previously selected channels, channel information sets for each channel and a plurality of channel related functions.

To achieve at least the above objects in a whole or in part and other advantages and in accordance with the purpose of the invention, as embodied and broadly described herein, a method of providing a channel history map according to the present invention includes building a database in a memory, the database including a plurality of channel information sets for channels that are previously tuned by a user in sequence; and displaying a channel history map based on the database using selectable On Screen Display when a request for displaying the history map is made by the user. Each channel information set can include a channel identifier and previous program information. The program information can include at least one of broadcasting date/hour information, a broadcasting station name, a program title, a program genre, and a program rating of at least one broadcasted program. The plurality of selectable channel-related functions can include a channel switch function, a preview function, an add/drop favorite channel function and a playback function.

To further achieve at least the above objects in a whole or in part and other advantages and in accordance with the purpose of the invention, as embodied and broadly described herein, a digital television system according to the present invention is provided that includes a memory, a control unit coupled to the memory for building a database in the memory, the database including a plurality of channel information sets for channels that are previously tuned by a user in sequence and a display unit coupled to the control unit for displaying a channel history map based on the database using a user-selectable device when a request for displaying said history map is made by the user.

To further achieve at least the above objects in a whole or in part and other advantages and in accordance with the purpose of the invention, as embodied and broadly described herein, a method according to the present invention is provided that includes building a database in a memory, the database including a plurality of channel information sets for channels that are previously tuned by a user according to a prescribed criteria, and outputting a channel history map based on the database when a request for the history map is made by the user.

To further achieve at least the above objects in a whole or in part and other advantages and in accordance with the purpose of the invention, as embodied and broadly described herein, a method of using a channel history map according to the present invention is provided that includes concurrently receiving first and second inputs from a user through a selectable channel history map, the first input determining one of a previously tuned plurality of channels as a selected channel, the second input determining one of a plurality of selectable channel-related functions as a selected function, and performing the selected channel-related function for the selected channel to select the function.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram that illustrates a preferred embodiment of a display apparatus according to the present invention;

FIG. 2 is a flow chart illustrating a preferred embodiment of a method of building a database for a channel history map according to the present invention;

FIG. 3 is a flow chart illustrating a a preferred embodiment of method of performing a channel-related function for a selected channel selected through a channel history map;

FIG. 4A is a diagram that illustrates an example of an On Screen Display (OSD) menu box for controllably displaying a channel history map;

FIG. 4B is a diagram that illustrates an example of a remote control device having a function button for a channel history map; and

FIG. 5 is a diagram that illustrates an example of a channel history map according to the present invention.

### DETAILED DESCRIPTION OF PREFERRED EMBODIMENTS

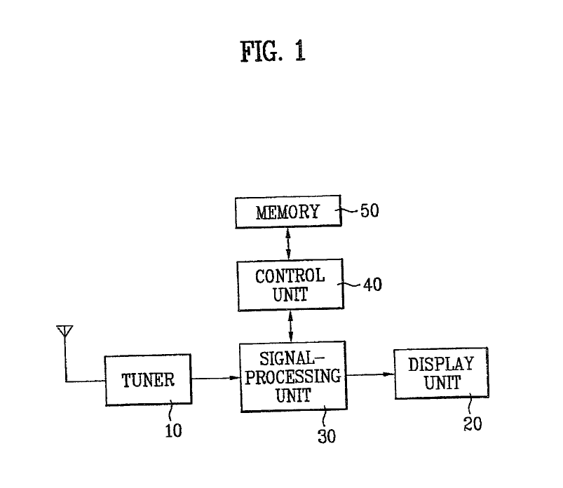

FIG. 1 illustrates a preferred embodiment of a display apparatus that can be a digital television system according to the present invention. As shown in FIG. 1, the digital television system can include a display unit 20, a tuner 10 tuning to a selected channel for receiving a corresponding broadcasting signal, and a signal processing unit 30. The signal processing unit 30 may perform the necessary signal-processing functions on the broadcasting signal of the tuned channel received through the tuner 10 for converting the signal into a video signal, audio signal and supplemental information of the tuned channel.

The supplemental information of each channel can be provided to the user using an On-Screen-Display (OSD) function such as an Electronic Program Guide (EPG) or through input in the broadcasting signal. The supplemental information of a channel preferably includes the broadcasting time and length, rating index (e.g., movie rating), program type, and other information of the programs being provided through the channel. The user initially looks into the supplemental information of a channel and is able to perform various channel-related functions such as channel pre-selecting function (e.g., favorite channel), a program recording function, and many others.

The television system shown in FIG. 1 can further include a control unit 40 and memory 50 preferably having a first memory space (e.g., buffer) for storing the supplemental information of the tuned channel and a second memory space for storing a channel history map that includes supplemental information of one or more prior channels that were selected prior to the currently tuned channel. The control unit 40 can update the channel history map stored in the memory 50 upon receiving a channel-switch command from a user and can generate a control signal to the display unit 20 for displaying the updated channel history map using an On Screen Display (OSD) function such as a information only or selectable dialog window. Upon receiving a channel-switch command, the control unit 40 preferably initially reads the supplemental information of the tuned channel from the first memory space of the memory 50 and updates the channel history map database stored in the second memory space of the memory 50 by storing the information read from the first memory space into the second memory space.

Operations of the system of FIG. 1 according to the present invention will now be described. When a user initially selects a desired channel of the television system, the tuner 10 tunes to the selected channel and receives a corresponding broadcasting signal through the tuned channel. The signal-processing unit 30 converts the broadcasting signal into video and audio signals and supplemental information of the tuned channel. Then, the audio and video signals are preferably outputted through a speaker (not illustrated) and the display unit 20, respectively. In addition, the supplemental information of the tuned channel are initially stored in the first memory space of the memory 50 in accordance with a control signal that the controller unit 40 generates, and the controller starts measuring the display time of the tuned channel.

When the user inputs a channel-switching command by pressing one or more buttons provided on a remote control device, a key panel of the television system or the like, the control unit 40 of the television system can read the supplemental information of the tuned channel from the first memory space of the memory 50 and updates a channel history map stored in the second memory space by storing the read information into the channel history map preferably upon determining whether the read data represent true data. The determination is preferably performed by comparing the read supplemental information with reference information of the television system.

Thereafter, the controller unit 40 of the television system generates necessary control signals so that the tuner 10 is able to tune to a newly selected channel according to the channel-switch command and receive a new broadcasting signal. The signal-processing unit 30 is able to convert the new broadcasting signal into video, audio, and supplemental information signals.

The control unit 40 may update the channel history map stored in the memory 50 each time when the user inputs a channel-switch command. The size of the channel history map, e.g., the number of the supplemental information sets of the previously selected channels, may depend on the storage capacity of the memory 50. Alternately, the size of the channel history map can depend on a total desired time (e.g., 30 minutes) of channel history. However, the present invention is not intended to be so limited to such exemplary determinations.

When the user inputs a command for displaying the channel map, the controller unit 40 generates a corresponding control signal in order for the display unit 20 to display the channel history map including the supplemental information of a number of previously selected channels preferably using an On-Screen-Display (OSD) function. Thereafter, using the displayed channel map, the user is able to give a command for performing any one of various channel-related functions such as CHANNEL-SWITCH, PREVIEW, and FAVORITE CHANNEL functions for a selected channel.

In a case where the user inputs a CHANNEL-SWITCH function command using the remote control device or key panel, the controller unit 40 preferably generates a control signal to the tuner 10 for tuning to a desired channel selected by the user.

In a case where the user inputs a PREVIEW function command, the control unit 40 reads the supplemental information (e.g., detailed story of a program) of a desired channel stored in the second memory space of the memory 50 and enables the display unit 20 to display the read information. Such read information can include text, a video preview or the like of the desired channel. The read information can include current time information, a prescribed time information or the like. If the television system supports a bilateral data communication, the control unit 40 may provide a Video On Demand (VOD) service by requesting to send a broadcasting signal of the desired channel. Such VOD can be limited to a set interval (e.g., 30 seconds).

In a case where the user inputs a FAVORITE CHANNEL function command, the control unit 40 registers a desired channel as a favorite channel. Such a FAVORITE CHANNEL function command may be implemented as a toggle function where an initial selection registers and a next selection of the same channel removes that channel as a favorite channel.

As shown in FIG. 1, the preferred embodiment is a digital television system. However, the present invention is not intended to be so limited. For example, the present invention is applicable to an apparatus being a set-top box or a method and apparatus for providing channel tuning information to a separate display apparatus such as a monitor of a television system.

The set of channel related functions can include added functions, for example, a playback function. Such a playback function would preferably be selectable with the selectable channel related functions in the OSD including the channel history map. Such a playback function can include playing back or reviewing the previously watched content for the selected channel, for example, at a prescribed or user selectable time. The playback function can perform on a prescribed amount or user selectable amount of time or video data.

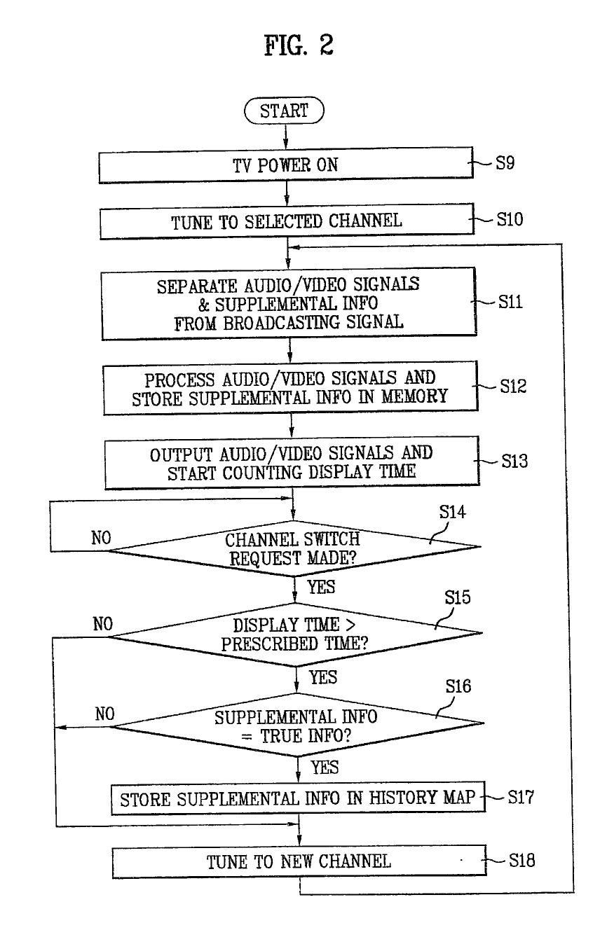

FIG. 2 is a flowchart that illustrates a preferred embodiment of a method of providing channel selection history information in accordance with the present invention. As shown in FIG. 2, the method will be described with respect to a digital television system. However, the present invention is not intended to be so limited. After a process starts as shown in FIG. 2, the digital television system shown in FIG. 1 is turned on (step S9). The control unit 40 of the television system preferably instructs the tuner 10 to tune to a channel and receive a corresponding broadcasting signal (step S10). For example, the channel may be the most recently selected channel before power off or a channel prescribed by a user or a manufacturer.

Next, the signal-processing unit 30 converts the broadcasting signal into audio and video signals and supplemental information corresponding to the tuned channel (step S11). The supplemental information of the tuned channel may include a channel identifier and previous program information including broadcasting date/time information, a broadcasting station name, a program title, a program genre, a program rating of at least one broadcasted program or the like.

Then, the signal-processing unit 30 performs the necessary processes on the audio and video signals, the separated supplemental information is stored in the first memory space of the memory 50 (step S12). Thereafter, the control unit 40 enables the display unit 20 and a speaker (not illustrated) of the television system respectively output the processed video and audio signals. The control unit 40 may count the display time of the channel tuned in the step S10 (step S13).

The control unit 40 can also determine whether a channel-switch command is received from a user (step S14). Such a determination can be repeatedly performed. If it is, then the control unit 40 can further check whether the display time of the tuned channel is greater than a prescribed period of time (step S15). If it is determined from the step S15 that the display time is greater than the prescribed period of time, then control unit 40 can further determine whether the supplemental information is true information (step S16) by checking whether the supplemental information conforms to the reference information of the television system, which can include present date/time information, an actual channel number of the tuned channel, a name of a broadcasting station, and/or a signal type of the broadcasting signal.

The broadcasting signal provider often includes the incorrect supplemental information (e.g., incorrect broadcasting time) in a broadcasting signal that the provider sends to many television systems. For example, when the broadcasting signal provider rebroadcasts a program which was initially broadcast at an earlier (e.g., different) time and the provider does not update the supplemental information, the broadcasting time indicated in the supplemental information may not properly correspond to the actual rebroadcasting schedule. By performing step S15, only channels watched by the user for a certain time will be entered into the channel history map. By performing the step S16, preferably such incorrect (false) information included in the rebroadcasting signal will not be incorporated into the channel history map stored in the second memory space and will not be provided to the user. When the respective determination in the steps S15 and S16 is negative, control can jump to step S18.

If it is determined from the step S16 that the supplemental information of the tuned channel conforms to the reference information of the television system, then the controller 40 stores the supplemental information in the second memory space of the memory 50 and can configure a channel-history map data (step S17). The tuner 10 tunes to the desired channel corresponding to the command received from the user in the step S14 (step S18). Preferably, the steps S12 to S17 are repeated until the user inputs no further channel-switch command in the step S14 or the television system is disabled. Therefore, each time the user inputs a channel-switch command, the control unit 40 stores the supplemental information of the presently tuned channel in the second memory space and updates the channel history map data accordingly before tuning to a desired channel according to the channel-switch command. Preferably, the process shown in FIG. 2 ends when the television system, the channel history capability is disabled, or the like

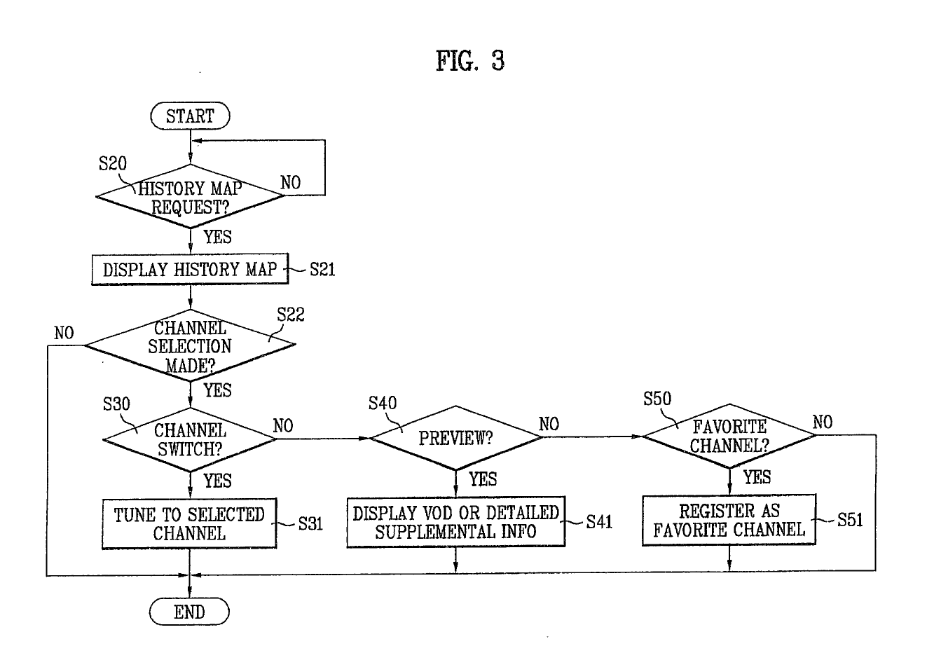

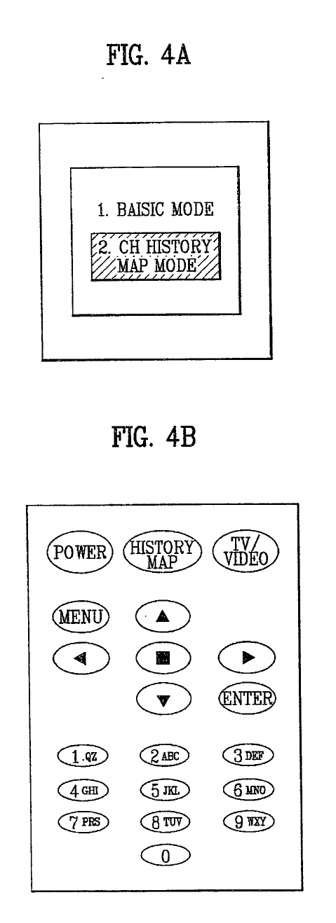

FIG. 3 is a flowchart that illustrates a preferred embodiment of a method of performing a channel-related function using a channel history map according to the present invention. The preferred embodiments of FIGS. 1 and 3 can preferably be performed together. As shown in FIG. 3, the control unit 40 of the television system initially checks whether a CH HISTORY MAP mode is set for displaying a channel history map (step S20). A user can set the CH HISTORY MAP mode by selecting a CH HISTORY MAP icon displayed on an exemplary OSD menu box as shown in FIG. 4A or by pressing an exemplary CH HISTORY MAP button provided on a remote control device as shown in FIG. 4B or the like. If it is determined from the step S20 that the CH HISTORY MAP mode is set by the user, then the control unit 40 instructs the display unit 20 to display a channel history map (step S21).

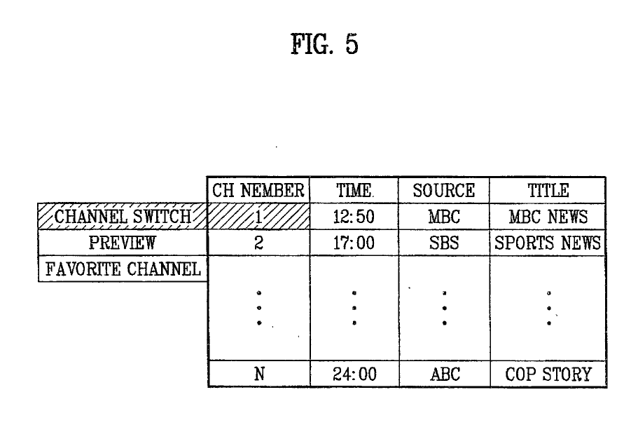

FIG. 5 illustrates an example of a channel history map that the display unit 20 displays using an OSD function when requested by the user. As shown in FIG. 5, the history map includes the history map data sets for a series of the previously selected channels, and the data sets may be arranged in an order of the previous channel selections. As shown in FIG. 5, the data set for each previously selected channel may include a channel identifier (e.g., channel number), the broadcasting time of a broadcasting program, the source (e.g., name of the broadcasting stations), and the title of the program.

Referring back to FIG. 3, the control unit 40 preferably further determines one of the channels indicated in the OSD channel history map the user has selected for performing one of channel-related functions such as CHANNEL SWITCH, PREVIEW, and FAVORITE CHANNEL functions (step S22). The selectable channel history map was displayed for user selection in the step S21. If it is determined from the step S22 that a channel-selecting command is received from the user, then the control unit 40 preferably determines which one of the above-described channel-related functions the user has selected (steps S30, S40, S50).

In a case where the user selects the CHANNEL SWITCH function using the channel history map, the control unit 40 can instruct the tuner 10 to tune to the selected channel and to receive a corresponding broadcasting signal (step S31). In a case where the user selects the PREVIEW function, the control unit 40 generates a control signal for performing a Video On Demand (VOD) service, displaying the detailed supplemental information of the selected channel using OSD or the like (step S41). In a case where the user selects the FAVORITE CHANNEL function, the control unit 40 determines the selected channel as one of favorite channels (step S51).

In brief summary, preferred embodiments of an apparatus and method according to the present invention can provide channel history information of the previous channel selections to a user. A user is able to perform a desired TV-related function for one of the previously selected channels using the provided channel history information. Accordingly, a user can select one of previously selected channels, pre-selected function or the like in a more efficient manner.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of providing a channel history map for a display apparatus, comprising:
building a database in a memory, said database including a plurality of channel information sets for channels that are previously tuned according to a prescribed criteria by a user; and
displaying the channel history map based on said database using an On Screen Display (OSD) when a request for said history map is made by said user.

2. The method of claim 1, wherein the prescribed criteria is one of a prescribed time period and a prescribed order of selection by said user.

3. The method of claim 1, wherein said plurality of channel information sets are arranged within said database in a sequential order that said channels are tuned by said user, wherein said channel history map is substantially continuous in time, and wherein said display apparatus is a digital television.

4. The method of claim 1, wherein said request for displaying said channel history map is made by pressing a function button provided on a remote control device or by selecting a function icon through an OSD menu.

5. The method of claim 1, wherein each channel information set includes a channel identifier and previous program information, said program information including at least one of broadcasting date/hour information, a broadcasting station name, a program title, a program genre and a program rating.

6. The method of claim 1, comprising:
receiving first and second inputs from said user through said displayed channel history map, said first input determining one of said previously tuned channels as a selected channel, said second input determining one of a plurality of selectable channel-related functions as a selected function; and
performing said selected function for said selected channel according to said first and second inputs.

7. The method of claim 6, wherein said plurality of selectable channel-related functions include
a channel switch function that tunes to said selected channel and receiving a corresponding broadcasting signal,
a preview function that displays previous program information of said selected channel, and
a favorite channel function that determines said selected channel as a favorite channel.

8. The method of claim 7, wherein said previous program information is at least one of a text description and a video on demand service.

9. The method of claim 1, wherein the step of building said database includes the steps of
(a) obtaining a channel information set for a current channel,
(b) storing said current channel information set into said memory upon receiving a channel-switch command from said user,
(c) tuning to a next channel indicated by said channel-switch command, and
(d) repeating the steps (a) to (c) for each additional channel-switch command received.

10. The method of claim 9, wherein said information set is stored into said memory only if a corresponding display time of said video signal is greater than a prescribed period of time.

11. The method of claim 9, wherein said information set is stored into said memory only if said channel information set conforms to reference information of said tuned channel.

12. The method of claim 11, wherein said reference information includes at least one of present date/time information, an actual channel number of said tuned channel, and a signal type of said broadcasting signal.

13. The method of claim 9, wherein said information set is stored into said memory only if a corresponding display time of said video signal is greater than a prescribed period of time and said channel information set conforms to reference information for said tuned channel, and wherein said obtaining the current channel information set comprises one of separating a video signal and the current channel information set from a broadcasting signal being received through the current channel and determining the current channel information set from an electronic program guide.

14. The method of claim 1, wherein the building said database comprises:
(a) tuning to an initial channel;
(b) receiving a broadcasting signal through said tuned channel and separating a video signal and a channel information set from said broadcasting signal;
(c) processing said video signal and storing said information set in a first memory;
(d) displaying said video signal on a display device and beginning to measure a corresponding display period for said tuned channel;
(e) determining whether said display period is greater than a prescribed period of time if a channel-switch command is received from said user;
(f) determining whether said information set represents current information for said tuned channel if said display time is greater than said prescribed period,
(g) storing said channel information set stored in said first memory into said memory if said information set is determined to be the current information,
(h) tuning to a next channel indicated by said received channel-switch command, and
(i) repeating the steps (b) to (h) for said next channel.

15. The method of claim 14, wherein said information set is determined to be the current information if said information set conforms to reference information of said next channel, said reference information including at least one of present date/time information, an actual channel number of said tuned channel, and a signal type of said broadcasting signal.

16. The method of claim 1, wherein an oldest to a most recent of said plurality of channel information sets are substantially continuous in time.

17. The method of claim 16, wherein said plurality of channel information sets in the channel history map depict information for a prescribed period of time or a prescribed number of previous channels, and wherein said most recent channel is a previous channel.

18. A digital television system, comprising:
a memory;
a control unit coupled to said memory for building a database in said memory, said database including a plurality of channel information sets for channels that are previously tuned by a user in sequence; and
a display unit coupled to said control unit for displaying a channel history map based on said database using a user-selectable device when a request for displaying said history map is made by said user.

19. The apparatus of claim 18, wherein said plurality of channel information sets are arranged within said database in a sequential order that said channels are tuned by said user.

20. The apparatus of claim 18, wherein each channel information set includes a channel identifier and previous program information, said program information including at least one of broadcasting date/hour information, a broadcasting station name, a program title, a program genre, and a program rating of at least one broadcasted program.

21. The apparatus of claim 18, wherein said control unit performs a selected function for a selected channel based on first and second signals upon concurrently receiving the first and second signals according to said user through said displayed channel history map, said first signal determining one of said previously tuned channels as said selected channel and said second signal determining one of a plurality of selectable channel-related functions as said selected function.

22. The apparatus of claim 21, wherein said plurality of selectable channel-related functions includes
a channel switch function that tunes to said selected channel and receiving a corresponding broadcasting signal,
a preview function that displays previous or current program information of said selected channel using text or video on demand service, and
a favorite channel function that determines said selected channel as a favorite channel.

23. The method of claim 18, wherein an oldest to a most recent of said plurality of channel information sets are substantially continuous in time, wherein said plurality of channel information sets in the channel history map depict information for a prescribed period of time or a prescribed number of previous channels, and wherein said most recent channel is a previous channel.

24. A method, comprising:
building a database in a memory, said database including a plurality of channel information sets for channels that are previously tuned by a user according to a prescribed criteria; and
outputting a channel history map based on said database when a request for said history map is made by said user.

25. The method of claim 24, wherein said plurality of channel information sets are substantially continuous in time.

26. A method of using a channel history map, comprising:
concurrently receiving first and second inputs from a user through a selectable channel history map, said first input determining one of a previously tuned plurality of channels as a selected channel, said second input determining one of a plurality of selectable channel-related functions as a selected function; and
performing said selected channel-related function for said selected channel to select said function.

27. The method of claim 26, wherein an oldest to a most recent of said plurality of channel information sets are substantially continuous in time, wherein each channel information set includes a channel identifier and previous program information, said program information including at least one of broadcasting date/hour information, a broadcasting station name, a program title, a program genre and a program rating, and wherein said plurality of selectable channel-related functions include
a channel switch function that tunes to said selected channel and receiving a corresponding broadcasting signal,
a preview function that displays previous program information of said selected channel, and
a favorite channel function that determines said selected channel as a favorite channel.
